(19) United States
(12) Patent Application Publication
(10) Pub. No.: US 2013/0098322 A1
(43) Pub. Date: Apr. 25, 2013

(54) Methods of Controlling Sulfur Trioxide Levels in Internal Combustion Engines

(71) Applicants: Anthony P. Tonti, Montville, OH (US); James H. Bush, Mentor, OH (US); Andres Serrano Velasco, Gates Mills, OH (US)

(72) Inventors: Anthony P. Tonti, Montville, OH (US); James H. Bush, Mentor, OH (US); Andres Serrano Velasco, Gates Mills, OH (US)

(73) Assignee: THE LUBRIZOL CORPORATION, Wickliffe, OH (US)

(21) Appl. No.: 13/510,982

(22) PCT Filed: Nov. 1, 2010
(86) PCT No.: PCT/US10/54908

§ 371 Date: Aug. 6, 2012

Related U.S. Application Data
(60) Provisional application No. 61/264,876, filed on Nov. 30, 2009.

(51) Int. Cl. F02B 43/00

(52) U.S. Cl. CPC F02B 43/00
USPC 123/1 A

(57) ABSTRACT

The present invention relates methods of operating internal combustion engines and particularly marine diesel engines that result in reduced levels of sulfur trioxide, and similar corrosive and/or harmful byproducts of combustion. The present invention allows for the use of a lower TBN engine lubricant with a fuel of given sulfur and/or the use of a higher sulfur content fuel with an engine lubricant of a given TBN content than would otherwise be possible, without risking corrosive damage to engine.

### FIELD OF INVENTION

The present invention relates methods of operating internal combustion engines and particularly marine diesel engines that result in reduced levels of sulfur trioxide, and similar corrosive and/or harmful byproducts of combustion. The present invention allows for the use of a lower TBN engine lubricant with a fuel of given sulfur and/or the use of a higher sulfur content fuel with an engine lubricant of a given TBN content than would otherwise be possible, without risking corrosive damage to engine.

### BACKGROUND OF THE INVENTION

Controlling corrosive combustion byproducts, such as sulfur trioxide and similar materials resulting from the combustion of sulfur-containing fuels in internal combustion engines, is a serious concern for the owners and operators of such engines and the equipment they power. Diesel engines, and in particular marine diesel engines, use a wide variety of fuels that can have very different sulfur levels, and so very different needs when it comes to controlling these corrosive combustion byproducts.

Inadequate control of these byproducts can lead to a build-up of corrosive materials in the engine, and specifically in the engine cylinder. These materials can cause corrosive damage to the engine parts as well as deposit formation, particularly on the cylinder liners and piston rings. Not only does this impair the operation of the engine but can also lead to expensive repairs and costly down-time for the engines and the equipment they power.

Operator's generally deal with this challenge by using engine lubricants with high amounts of basic additives. These additives generally have a high total base number (TBN) such that they neutralize the corrosive combustion byproducts they come into contact with and so protect the engine from the damage described above. As different fuels have different sulfur contents, different lubricants, with different amounts of high-TBN additives are used, matching the TBN of the lubricant with the sulfur content of the fuel.

As high-TBN additives are expensive, and as the presence of excess TBN additives can lead to increased deposit formation in an engine over time, there are multiple motivators for using a lubricant with the minimum TBN (that is, the minimum level of high-TBN additives) as possible.

Recent regulations that have been developing across multiple countries are leading to complications. Many governments have begun to regulate the types of fuels that may be used in certain engines, and specifically in marine diesel engines, when the engine is operating in their jurisdictions, including their waters. These developing regulations generally require such engines to use cleaner burning fuels, which generally means fuels with lower sulfur contents among other parameters. Given the difference in regulations from government to government, as well as the significant price difference between cheaper high sulfur content fuels and more expensive, cleaner, low sulfur content fuels, there are multiple motivators to use the higher sulfur content fuel whenever possible and to only switch to the more expensive cleaner fuel when necessary. This has resulted in many engine operators adopting fuel switching practices, where they use the most inexpensive fuel they can depending on where they are operating at the time.

The American Petroleum Institute (API) is aware of these trends and has issued technical reports on fuel switching practices. These reports emphasis the importance of evaluating an engine's lubricant, and in the case of marine diesel engines particularly the engine's cylinder lubricant, when doing any fuel switching.

Given that the engine's lubricant, particularly a marine diesel engine's cylinder lubricant, is specifically selected to match the properties of the fuel being used in the engine, it should come as no surprise that an operator would have to consider switching the lubricant whenever switching the fuel. The API suggests selecting a lubricant that will have sufficient TBN for the highest sulfur content fuel expected to be used in the engine. The problem with this approach is that it would lead to many situations where the engine lubricant has excess TBN, relative to the amount corrosive combustion byproducts to be neutralized. This would be the case any time the engine is operating on a fuel with a sulfur content below the maximum level with which the lubricant was matched. As noted above, this can lead to increases in engine deposits.

There is a need for methods of operating internal combustion engines, and specifically marine diesel engines, that allows for a lubricant, and specifically a cylinder lubricant, with a given TBN to be used with wide variety of fuels, where the fuels contain different levels of sulfur, where the engine is not at increased risk for corrosive damage from neutralized combustion byproducts and where the engine is also not at risk for increased engine deposits resulting from excess high-TBN additives.

It would be useful to have a method of operating a marine diesel engine such that converting the engine from one fuel source to another, where the first fuel has a significantly different sulfur content than the second fuel, does not require the cylinder lubricant to be switched to a different cylinder lubricant with a TBN level matched to the second fuel.

It would also be useful to have a method of operating a marine diesel engine where the TBN supplying additives typically present in the cylinder lubricant can be used more effectively, thus reducing the amount of TBN supplying additives needed to neutralize the combustion byproducts in the cylinder of a marine diesel engine

### SUMMARY OF THE INVENTION

The present invention provides a method of operating an engine, particularly a marine diesel engine, comprising the steps: (i) supplying to the engine a fuel composition comprising (a) a marine fuel and (b) a metal-containing detergent; where the fuel composition has a sulfur content of at least 0.5 percent by weight; and (ii) supplying to the engine a cylinder lubricating composition wherein the total base number (TBN) of the cylinder lubricating composition is less than or equal to 70.

In some embodiment the methods of the present invention result in reduced corrosion in the engine. In other embodiments the methods of the present invention result in equivalent performance, (including equivalent corrosions protection and/or emissions control), when compared to the performance of engines operated outside the embodiments of the present invention when such engines use a fuel with a lower sulfur content and/or a lubricant with a higher TBN.

The present invention provides for methods of operating such engines where the fuel composition is a high sulfur fuel and/or the cylinder lubricating composition is a low TBN lubricant where the operation of the engine results in equivalent or reduced sulfur trioxide exhaust emissions and/or equivalent or increased residual cylinder lubricant TBN. These improvements are compared to the corresponding values obtained where: (i) the engine is operated with a fuel composition that does not contain component (b); (ii) the engine is operated with a fuel having a lower sulfur content; (iii) the engine is operated with a cylinder lubricant having a higher TBN; or (iv) combinations thereof.

The present invention also provides for methods of operating such engines where the fuel composition is a low sulfur fuel having a sulfur content of and the cylinder lubricating composition is a low TBN lubricant where the operation of the engine results in equivalent or reduced sulfur trioxide exhaust emissions and/or equivalent or increased residual cylinder lubricant TBN. These improvements are compared to the corresponding values obtained where: (i) the engine is operated with a fuel composition that does not contain component (b); (ii) the engine is operated with a fuel having a lower sulfur content; (iii) the engine is operated with a cylinder lubricant having a higher TBN; or (iv) combinations thereof.

### DETAILED DESCRIPTION OF THE INVENTION

Various features and embodiments of the invention will be described below by way of non-limiting illustration.

The basicity of a material is generally expressed in terms of a total base number (TBN). A TBN is the amount of acid (perchloric or hydrochloric) needed to neutralize all of the material's basicity. The amount of acid is expressed as units of potassium hydroxide (mg KOH per gram of sample). TBN is determined by titration of one gram of overbased material with 0.1 Normal hydrochloric acid solution using bromophenol blue as an indicator. The equivalents of an overbased material are determined by the following equation: equivalent weight=(56,100/TBN).

In many internal combustion engines, for example 2-stroke engines, and especially marine diesel engines or stationary power diesel engines, there are two lubricating compositions. One composition is a system oil with a viscosity generally less than 12 mm²/s, which is used to lubricate the crankcase of the 2-stroke engine and which has a low (TBN). The system oil is normally unsuitable for lubricating cylinder liners and piston rings because of its low TBN and low viscosity. The second lubricating composition used in a 2-stroke engine generally has a higher viscosity and higher TBN and is suitable for lubricating cylinder liners and piston rings. This is sometimes referred to as a cylinder oil. (All viscosities reported herein are kinematic viscosity measured at 100° C., unless otherwise specified).

The TBN of the cylinder oil is particularly critical as the engine relies on it to neutralize the acidic sulfur-containing combustion byproducts that result from the sulfur in the fuel. If there is too little TBN in the cylinder oil, not all of the acidic sulfur-containing combustion byproducts will be neutralized, and as these byproducts build-up in the engine, they can cause corrosive damage to the engine parts as well as deposit formation, particularly on the cylinder liners and piston rings. If there is too much TBN in the cylinder oil, the engine will see increased deposits.

As noted above, current attempts to overcome the problems related to different sulfur contents in marine diesel fuels involve operators using a higher TBN lubricant than they always need, or to keep two different cylinder lubricants on hand for when they switch fuels.

The present invention avoids the need for using a lubricant with a TBN higher than what is needed while also avoiding the needs to switch the lubricant when switching the engine to a fuel with a different sulfur content. The present invention provides a method of operating an engine where some portion of the TBN-supplying additives that would typically be present in the engine oil is instead present in the fuel supplied to the engine.

This modification is particularly useful in large diesel engines that use two separate lubricating composition and/or engine oils. Such engines generally use a system and/or crankcase oil and then also use a cylinder oil. By placing some portion of the TBN-supplying additives in the fuel instead of the cylinder oil, the present invention allows for the same cylinder oil to be used effectively with a wider range of fuels, and specifically a wider range of sulfur contents that may be present in the fuels.

As noted above, currently a cylinder oil is selected, at least in part, based on its TBN in order to match it against the sulfur level of the fuel it is to be used with. The present invention removes this limitation by providing a method where the TBN is delivered via the fuel, thus reducing the need to modify and/or replace the cylinder oil when the sulfur content of the fuel being used changes, and avoiding the need to use a cylinder oil with excess TBN.

The present invention allows for a lubricant with a given TBN to be used with a fuel with a sulfur content higher than would otherwise be possible without risking damage to the engine. In some embodiments, the present invention allows for the use of a lubricant with a TBN of no more than 75, 71 70, 60, 50, 45, 40, 30 or even 20 to be used with a fuel with a sulfur content of at least 0.5, 1.0, 1.5, 2.0, 3.0, 4.0, 4.5, or even 5.0 percent by weight.

The present invention also allows for a fuel with a given sulfur level to be used with a lubricant with a TBN lower than would otherwise be possible without risking damage to the engine. In some embodiments, the present invention allows for the use of a fuel with a sulfur content of at least 0.5, 1.0, 1.5, 2.0, 3.0, 4.0, 4.5, or even 5.0 percent by weight with a lubricant with a TBN of no more than 70, 60, 50, 40, 30 or even 20.

In any of the embodiments described herein, which represent a particularly advantageous set of embodiments of the present invention, the engine can be a marine diesel engine, the lubricant can be a cylinder lubricant, and the fuel can be a marine diesel fuel.

In one embodiment the present invention allows for a given amount of high-TBN additive to work more effectively at neutralizing combustion byproducts, thus allowing a lower TBN level and/or smaller amount of high-TBN additive, delivered via the fuel, to effectively neutralize the same amount of combustion byproducts as a higher TBN level and/or larger amount of high-TBN additive, delivered via the cylinder oil.

In embodiments of the present invention where the same overall relative amount of TBN and/or high-TBN additive is supplied to the engine, and where some portion of the TBN that would typically be present in the lubricant is instead supplied via the fuel, and where the sulfur content of the base fuel is held constant (that is, excluding any sulfur contributed to the fuel by the TBN supplying additives of the present invention, the sulfur content of the fuel is unchanged), the benefits of the present invention may be demonstrated by: reduced sulfur trioxide exhaust emissions from the engine, increased residual cylinder lubricant TBN, or combinations thereof.

In embodiments of the present invention where a lower overall relative amount of TBN and/or high-TBN additive is supplied to the engine, and where some portion of the TBN that would typically be present in the lubricant is instead supplied via the fuel, and where the sulfur content of the fuel is held constant, the benefits of the present invention may be demonstrated by equivalent and/or reduced sulfur trioxide exhaust emissions from the engine, equivalent and/or increased residual cylinder lubricant TBN, or combinations thereof.

In embodiments of the present invention where the same overall relative amount of TBN and/or high-TBN additive is supplied to the engine, and where some portion of the TBN that would typically be present in the lubricant is instead supplied via the fuel, and where the sulfur content of the fuel is increased, the benefits of the present invention may be demonstrated by: equivalent and/or reduced sulfur trioxide exhaust emissions from the engine, equivalent and/or increased residual cylinder lubricant TBN, or combinations thereof.

The residual TBN of the lubricant is the TBN of the lubricant at the end of test period, as opposed to the starting or fresh lubricant TBN. A higher residual TBN indicates less of the high-TBN additives in the lubricant have been consumed in the neutralization of the corrosive combustion byproducts. Assuming emissions levels have remained relatively stable across tests, an increase in the residual TBN is an indication that the neutralization occurred more effectively, consuming less of the high-TBN additive while maintaining the same level of emissions.

In any of these embodiments described herein, the methods of the present invention may result in a reduction in sulfur trioxide exhaust emissions of at least 5%, 10%, 15%, 20%, 25%, 35%, 50%, 60%, 80%, 90% or even 95% or near all, compared to the emission seen during typical operation of the same engine. These percent values may be on a weight basis, a volume basis, or a molar basis.

In any of these embodiments described herein, the methods of the present invention may result in a increased residual TBN of the cylinder lubricant, where the residual TBN is increased by 5%, 10%, 15%, 20%, 25%, 35%, 50%, 60%, 80%, 90%, compared to the residual TBN seen during typical operation of the same engine.

In some embodiments the methods of the present invention result in a residual cylinder lubricant TBN of at least 5, 10, 20 or even 30.

In any of the embodiments described herein, where the benefits of the present invention are described as providing an improvement, the basis of comparison can be the same engine operated under the same conditions except that component (b) is not present in the fuel composition. In some embodiments the comparison is made with the same lubricant. In other embodiments, the lubricant used in the comparative run can have a higher TBN in order to account for the TBN provided by component (b) in the fuel. In some embodiments, the benefits of the present invention are seen in both types of comparisons. In addition, comparisons may also be completed where the sulfur content of the fuel is varied in addition to the presence or absence of component (b) in the fuel and whether additional TBN is added (to the lubricant used in the comparative run) or removed (from the lubricant used in the inventive run). In some embodiments, the benefits of the present invention may been seen in one or more of any of these comparisons, which is why the benefits of the present invention may include both improved performance or equivalent performance, depending on the basis of the comparison made.

In one embodiment, the present invention involves the operation of an engine using a high sulfur fuel having a sulfur content of greater than 4%, 4.5% or even 5% by weight and a low TBN cylinder lubricating composition with a TBN of less than 65, 50, 40 or even 30. In such embodiments the invention may provide any of the benefits described above.

In another embodiment, the present invention involves the operation of an engine using a low sulfur fuel having a sulfur content of 0.5 to 4% by weight, or a sulfur content less than 1% or even less than 0.5% by weight and a low TBN cylinder lubricating composition with a TBN of less than 40 or even 30. In such embodiments the invention may provide any of the benefits described above.

### The Engine

The methods of the present invention are useful for internal combustion engines, for example stationary combustion engine, such as a power station combustion engine; a diesel fuelled engine. In one embodiment the internal combustion engine is a 4-stroke and in another embodiment a 2-stroke engine. In one embodiment the diesel fuelled engine is a marine diesel engine. The methods of the present invention include the steps of operating an engine and supplying the compositions described above to the engine. In some embodiments, the lubricating compositions described herein are used as cylinder oils in a marine diesel engine. In some embodiments, lubricating compositions described herein are not marine diesel engine system oils and/or crankcase oils and are not used in marine diesel engines as system oils and/or crankcase oils.

Suitable marine diesel engines for use with the compositions and methods of the present are not overly limited. Suitable engines include 4-stroke trunk piston engines as well as 2-stroke cross-head engines that utilize a cylinder oil.

### The Fuel.

The fuels suitable for use in the present invention are not overly limited and may be any fuel suitable for use in the engine involved. In one embodiment the fuel is a diesel fuel. In another embodiment the fuel is a marine diesel fuel. When the term marine diesel fuel is used herein, it is meant to include distillate fuels, intermediate fuels, and residual fuels.

Distillate fuels are composed of petroleum fractions of crude oil separated in a refinery by a boiling process called distillation. Residual fuels are composed of the fraction of crude oil that did not boil in the distillation process. Intermediate fuels are composed of mixtures of the two other types.

Specific examples of distillate fuels include DMX, DMA, DMB, and DMC, which are often referred to in the industry as gas oils, marine gas oils or marine distillate (DM) fuel. Specific examples of intermediate fuels include IFO-180 and IFO-380, which are often referred to in the industry as marine diesel fuel or intermediate fuel oils (IFO). Specific examples of residual fuels include RMA and RML fuels, such as RML-55, and are often referred to in the industry as fuel oils, residual fuel oils, or residual marine (RM) fuels. Individual grades of residual marine (RM) fuels are designed by letters A to H, K and L, for example RMA-10, RME-25, RMF-25, RMG-35 and RMH-1-35. The number in the fuel identification is typically the fuel's maximum viscosity at 100 degrees C.

In one embodiment the fuel may be DMA, No. 2 Fuel Oil, DMC, IFO-180, or IFO-380. No. 2 Fuel Oil, also called home heating oil, is sometimes used in marine diesel engines when the more typical fuels are in short supply. In another embodiment the fuel may be DMA, DMB, DMC, RME-25, RMF-25, IFO-180, RMG-35, RMH-35, IFO-380 or RML-55. In still another embodiment the may be No. 2 diesel fuel, No. 4 diesel fuel, No. 6 diesel fuel, heavy fuel oil bunker fuel, residual fuel, or combinations thereof. Bunker fuel, or heavy fuel oil bunker fuel, can broadly include any fuel oil used aboard ships. Bunker fuel is most commonly used to refer to residual fuels and specifically No. 5 fuel oil and No. 6 fuel oil, which are both residual fuel oils, or heavy fuel oils. Any of these fuels may be used in combinations, and lighter fuels are sometimes mixed with heavier fuels to adjust their properties and/or improve their handling.

The fuel may have a minimum flash point of 60 degrees C. The fuel may also have a kinematic viscosity at 40 degrees C. of no more than 15 or even 12 centistokes. The fuel may also have a kinematic viscosity at 100 degrees C. of no more than 60 or even 55 centistokes.

In one embodiment the fuel is a marine diesel fuel with a sulfur content of at least 0.5%, 1.0%, 1.5%, 2.0%, 3.0%, 4.0%, 4.5%, or even 5.0% by weight. In other embodiments the fuel is a marine diesel fuel with a sulfur content of no more than 0.5%, 1.0%, 1.5%, 2.0%, 3.0%, 4.0%, 4.5%, or even 5.0% by weight. The fuel may also have a sulfur content with a range of 0.5%, 1.0%, 1.5%, 2.0%, 3.0%, 4.0%, 4.5%, or even 5.0% by weight to 1.0%, 1.5%, 2.0%, 3.0%, 4.0%, 4.5%, 5.0% or even 10.0% by weight. These limits may apply to the fuel used in the fuel composition of the present invention, or to the overall fuel composition itself.

The fuel compositions of the present invention may also include one or more additional additives. Any fuel additive may be used and the types, combinations, and amounts of additives present are not overly limited. These additional additives may include a combustion improver, a cetane improver, an emulsifier, an antioxidant, an antifoam agent, a corrosion inhibitor, a wax crystal modifier, a distillate flow improver, a liner lacquering reducing agent, an asphaltene dispersant, a demulsifier, or combinations thereof.

When present, these additional additives may make up from 0%, 0.1%, 0.5%, 1.0% or even 5.0% by weight up to 0.5%, 1.0%, 4%, 10% or even 15% of the fuel composition.

### The Metal-Containing Detergent.

The fuel compositions used in the present invention include component (b), a metal-containing detergent. In one embodiment, the detergent component may include overbased metal sulfonates, alkyl phenol detergents, salicylate detergents, carboxylates, or combinations thereof.

In some embodiments the metal-containing detergent is an overbased material, which are also referred to as overbased or superbased salts. Such materials are generally homogeneous Newtonian systems characterized by an amount of excess metal that which would be necessary for neutralization according to the stoichiometry of the metal and the particular acidic organic compound reacted with the metal. The amount of excess metal is commonly expressed in terms of “substrate to metal ratio” which is the ratio of the total equivalents of the metal to the equivalents of the substrate. A more detailed description of the term metal ratio is provided in “Chemistry and Technology of Lubricants”, Second Edition, Edited by R. M. Mortier and S. T. Orszulik, pages 85 and 86, 1997.

The basicity of overbased materials is generally expressed in terms of a total base number (TBN). A TBN is the amount of acid (perchloric or hydrochloric) needed to neutralize all of the overbased material's basicity. The amount of acid is expressed as unit of potassium hydroxide (mg KOH per gram of sample). TBN is determined by titration of one gram of overbased material with 0.1 Normal hydrochloric acid solution using bromophenol blue as an indicator. The equivalents of an overbased material are determined by the following equation: equivalent weight=(56,100/TBN).

Detergents may be prepared by reacting an acidic material (typically an inorganic acid or lower carboxylic acid, for example carbon dioxide) with a mixture comprising an acidic organic compound, a reaction medium comprising at least one inert, organic solvent (mineral oil, naphtha, toluene, xylene, etc.) for said acidic organic material, and optionally a stoichiometric excess of a metal base, and a promoter. The reaction of the acidic organic compound with the metal base, in the presence of the promoter and acidic material may result in a neutral detergent, with a relatively low TBN (for example less than 100, 50 or even 10), or it may result in an overbased detergent with a high TBN (for example at least 100, 200, or even 300). Multiple reaction steps may be completed, adding additional metal base, and additional amounts of promoter and acidic material as needed, to result produce an overbased detergent.

Useful acidic organic compounds include carboxylic acids, sulfonic acids, phosphorus-containing acids, phenols (including alkylated phenols) or mixtures of two or more thereof. In some embodiments the acidic organic compounds are sulfonic acids or phenols. Throughout this specification, any reference to acids, such as carboxylic or sulfonic acids, is intended to include the acid-producing derivatives thereof such as anhydrides, lower alkyl esters, acyl halides, lactones and mixtures thereof, unless otherwise specifically stated.

Suitable detergents include calcium sulfonates and overbased calcium sulfonates. Such detergents are prepared by reacting an acidic material (typically an inorganic acid or lower carboxylic acid, preferably carbon dioxide) with a mixture comprising a sulfonic acid, a reaction medium comprising at least one inert, organic solvent (mineral oil, naphtha, toluene, xylene, etc.) for said acidic organic material, optionally a stoichiometric excess of a metal base, and a promoter.

Suitable acids include sulfonic and thiosulfonic acids, and salts thereof, and also include mono or polynuclear aromatic or cycloaliphatic compounds. The oil-soluble sulfonates can be represented for the most part by one of the following formulae: R₂-T—(SO₃⁻)ₐ, and R₃—(SO₃⁻)_{b}, wherein T is a cyclic nucleus such as benzene, toluene, naphthalene, anthracene, diphenylene oxide, diphenylene sulfide, petroleum naphthenes, or combinations thereof; R₂ is an aliphatic group such as alkyl, alkenyl, alkoxy, alkoxyalkyl, or combinations thereof; (R₂)+T contains a total of at least 15 carbon atoms; and R₃ is an aliphatic hydrocarbyl group containing at least 15 carbon atoms. R₃ may be an alkyl, alkenyl, alkoxy alkyl, or carboalkoxyalkyl group. In one embodiment, the sulfonic acids have a substituent (R₂ or R₃) derived from a polyalkene, and in some embodiments may be derived from polyisobutylene (PIB).

Suitable polyalkenes, from which the alkyl group of the sulfonic acid may be derived, include homopolymers and interpolymers of polymerizable olefin monomers of 2 to 16 carbon atoms. The olefins may be monoolefins such as ethylene, propylene, 1-butene, isobutene, and 1-octene; or a polyolefinic monomer, preferably diolefinic, monomer such 1,3-butadiene and isoprene. Preferably the monomers contain from 2 to 6 or 4 carbon atoms. The interpolymers include copolymers, terpolymers, tetrapolymers and the like. Preferably, the polymer is a homopolymer. In some embodiments the polymer is a polypropylene or a polybutene, for example a polybutene in which 50% of the polymer is derived from isobutylene. The polyalkenes are prepared by conventional procedures. In some embodiments the alkyl group in derived from isomerized alpha olefins and contains from 18 to 24 carbon atoms. The sulfonic acid may be derived from alkyl benzene, alkyl toluene, or combinations thereof where the alky group is as defined above, and in some embodiments contains from 18 to 24 carbon atoms.

The alkyl groups of the sulfonic acids, and so the polyalkenes from which they are derived can have an Mn (number average molecular weight) of from 500, 750, or 850 up to 5000, 3000, 2000, or 1600, and the polydispersity, (Mw/Mn), that is, the ratio of the weight average molecular weight over the number average molecular weight, is from 1.5, 1.8, or 2, or to 2.5, 3.6, or 3.2.

The PIB may be conventional PIB or highly reactive and/or high vinylidene PIB. In one embodiment the PIB used is conventional PIB, in another embodiment the PIB used is highly reactive PIB, and in still another embodiment the PIB used is a mixture of conventional and highly reactive PIB.

The production of sulfonates is well known to those skilled in the art. See, for example, the article “Sulfonates” in Kirk-Othmer “Encyclopedia of Chemical Technology”, Second Edition, Vol. 19, pp. 291 et seq. published by John Wiley & Sons, N.Y. (1969).

The metal compounds useful in making the basic metal salts are generally Group 1 or Group 2 metal compounds. In some embodiments the metal used is sodium or potassium, or even sodium. In other embodiments the metals of the metal base include the Group 2a alkaline earth metals such as magnesium, calcium, and barium, as well as the Group 2b metals such as zinc. In some embodiments the Group 2 metals are magnesium, calcium, barium, or zinc, and in others, magnesium or calcium, and typically calcium. The metal compounds may be delivered as metal salts. The anionic portion of the salt can be hydroxide, oxide, carbonate, borate, and/or nitrate.

An acidic material may be used to accomplish the formation of the overbased detergent. The acidic material may be a liquid such as formic acid, acetic acid, nitric acid, and/or sulfuric acid. Acetic acid is particularly useful. Inorganic acidic materials may also be used such as CO₂. In some embodiments the material used is CO₂, often used in combination with acetic acid. An acidic gas may be employed to accomplish the formation of the overbased detergent, such as carbon dioxide or sulfur dioxide.

A promoter is a chemical employed to facilitate the incorporation of metal into the basic metal compositions. A particularly comprehensive discussion of suitable promoters is found in U.S. Pat. Nos. 2,777,874, 2,695,910, and 2,616,904. These include the alcoholic and phenolic promoters. The alcoholic promoters include the alkanols of 1 to 12 carbon atoms such as methanol, ethanol, amyl alcohol, butyl alcohol including i-butyl alcohol, octanol, isopropanol, and mixtures of these and the like. Phenolic promoters include a variety of hydroxy-substituted benzenes and naphthalenes. Mixtures of various promoters may be used.

Suitable detergents also include carboxylate detergents and overbased carboxylate detergents, sometime referred to simply as carboxylates. Such detergents are prepared by reacting an acidic material (typically an inorganic acid or lower carboxylic acid, preferably carbon dioxide) with a mixture comprising a carboxylic acid, a reaction medium comprising at least one inert, organic solvent (mineral oil, naphtha, toluene, xylene, etc.) for said acidic organic material, optionally a stoichiometric excess of a metal base, and a promoter.

Useful carboxylic acids include aliphatic or aromatic, mono- or polycarboxylic acid or acid-producing compounds. These carboxylic acids include lower molecular weight carboxylic acids (for example acids having up to 22 carbon atoms or from 4 to 22 carbon atoms) as well as higher molecular weight carboxylic acids. Suitable carboxylic acids are generally oil-soluble, and so may have at least 8, 18, 30 or even 50 carbon atoms and in most cases less than 400 carbon atoms per molecule. The acids may be saturated and unsaturated acids.

Examples of useful acids include dodecanoic acid, decanoic acid, oleic acid, stearic acid, isostearic acid, linoleic acid, tall oil acid and combinations thereof. An extensive discussion of these acids is found in Kirk-Othmer “Encyclopedia of Chemical Technology” Third Edition, 1978, John Wiley & Sons New York, pp. 814-871. Still further examples include palmitic acid, myristic acid, behenic acid, hexatriacontanoic acid, tetrapropylenyl-substituted glutaric acid, polybutenyl-substituted succinic acid derived from a polybutene (having an Mn of 200 or 300 to 1500 or 1000), polypropenyl-substituted succinic acid derived from a polypropene, (having an Mn of from 200 or 300 to 1000 or 900), octadecyl-substituted adipic acid, chlorostearic acid, 9-methylstearic acid, dichlorostearic acid, stearyl-benzoic acid, eicosanyl-substituted naphthoic acid, dilauryl-decahydronaphthalene carboxylic acid, mixtures of any of these acids, their alkali and alkaline earth metal salts, and/or their anhydrides.

In one embodiment, the carboxylic acid includes the saturated and unsaturated higher fatty acids containing from 12 to 30 carbon atoms, such as lauric acid, palmitic acid, oleic acid, linoleic acid, linolenic acid, oleostearic acid, stearic acid, myristic acid, and undecylenic acid, alpha-chlorostearic acid, and alphanitrolauric acid.

Suitable acids also include: alkylalkyleneglycol-acetic acid, and more preferably alkylpolyethyleneglycol-acetic acid: aromatic carboxylic acids, such as substituted and non-substituted benzoic, phthalic and salicylic acids or anhydrides.

Suitable detergents also include salicylate detergents and overbased salicylate detergents. Such detergents are prepared by reacting an acidic material (typically an inorganic acid or lower carboxylic acid, preferably carbon dioxide) with a mixture comprising a salicylic acid, a reaction medium comprising at least one inert, organic solvent (mineral oil, naphtha, toluene, xylene, etc.) for said acidic organic material, optionally a stoichiometric excess of a metal base, and a promoter.

As noted above, salicylic acids are a subset of aromatic carboxylic acids. When these types of acids are used to prepare the detergent, the resulting material is generally referred to as a salicylate. Suitable salicylic acids can be aliphatic hydrocarbon-substituted salicylic acids wherein each hydrocarbon substituent contains an average of at least 8 carbon atoms per substituent and 1 to 3 substituents per molecule. In one embodiment the overbased salts are prepared from salicylic acids with aliphatic hydrocarbon substituents derived from any of the above-described polyalkenes, particularly polymerized lower 1-mono-olefins such as polyethylene, polypropylene, poly-isobutylene, and ethylene/propylene copolymers and having average carbon contents of 30 to 400 carbon atoms.

Carboxylic acids of the type described above and processes for preparing their neutral and basic metal salts are well known and disclosed, for example, in U.S. Pat. Nos. 2,197,832; 2,197,835; 2,252,662; 2,252,664; 2,714,092; 3,410,798; and 3,595,791.

The overbased salt may also be a borated complex. Borated complexes of this type can be prepared by heating the basic metal salt with boric acid at about 50-100° C., the number of equivalents of boric acid being roughly equal to the number of equivalents of metal in the salt. U.S. Pat. No. 3,929,650 discloses such borated complexes and their preparation.

Suitable overbased detergents also include those derived from phenol and alkylated phenols, which may be referred to as phenates, for example calcium phenate sulfides. The phenate may be a sulphur-containing phenate, a methylene-bridged phenate, or mixtures thereof. In one embodiment the phenate is sulphur-containing/coupled phenate. Such materials are described in U.S. Pat. No. 6,551,965 and EP Publications EP 1903093 A, EP 0601721 A, EP 0271262B2 and EP 0273588 B2.

Suitable phenate detergents may be fowled by reacting an alkylphenol, an alkaline earth metal base and sulfur, typically carried out in the presence of a promoter solvent to form a sulfurized metal phenate. The alkylphenols useful in the present invention are of the formula R(C₆H₄)OH where R is a straight chain or branched chain alkyl group having from 8 to 40 or from 10 to 30 carbons, and the moiety (C₆H₄) is a benzene ring. Examples of suitable alkyl groups include octyl, decyl, dodecyl, tetradecyl, and hexadecyl groups

The alkaline earth metal base can be any of those described above and in some embodiments are calcium and/or magnesium. Examples include calcium oxide, calcium hydroxide, barium oxide, barium hydroxide, magnesium oxide, and the like. Calcium hydroxide, also called hydrated lime, is most commonly used. The promoter solvent, also called a mutual solvent, can be any stable organic liquid which has appreciable solubility for the alkaline earth metal base, the alkylphenol, and the sulfurized metal phenate intermediate. Suitable solvents include glycols and glycol monoethers such as ethylene glycol, 1,4-butane diol, and derivatives of ethylene glycol, such as monomethyl ether, monoethyl ether, etc. In one embodiment the solvent is one or more vicinal glycols and in another embodiment the solvent includes ethylene glycol. The sulfur used in the reaction may be elemental sulfur, in the form of molten sulfur.

In some embodiments the phenate detergent is prepared in the presence of a co-surfactant. Suitable co-surfactants include low base alkylbenzene sulfonates, hydrocarbyl substituted acylating agents such as polyisobutenyl succinic anhydrides (PIBSA), and succinimide dispersants such as polyisobutenyl succinimides. Suitable sulfonates include sulfonic acid salts having a molecular weight preferably of more than 400 obtained by sulfonating alkyl-benzenes derived from olefins or polymers of C2-C4 olefins of chain length C15-C80 and alkaline earth metals such as calcium, barium, magnesium etc. Suitable co-surfactants include and/or may be derived from PIBSA, which may itself be derived from 300 to 5000, or 500 to 3000, or 800 to 1600 number average molecular weight polyisobutylene.

As noted above, these phenate detergents are overbased by reacting them with carbon dioxide gas in the presence of additional alkaline earth meal base, typically in the presence of a promoter solvent. In one embodiment, the phenate sulfide detergents of the composition can be represented by the formula:

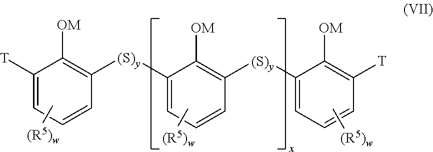

wherein the number of sulphur atoms y can be in the range from 1 to 8, 6 or 4; R⁵ can be hydrogen or hydrocarbyl groups; T is hydrogen or an (S)_{y} linkage terminating in hydrogen, an ion or a non-phenolic hydrocarbyl group; w can be an integer from 0 to 4; and M is hydrogen, a valence of a metal ion, an ammonium ion and mixtures thereof.

When M is an equivalent of a metal ion, the metal can be monovalent, divalent, trivalent or mixtures of such metals. When monovalent, the metal M can be an alkali metal, such as lithium, sodium, potassium or combinations thereof. When divalent, the metal M can be an alkaline earth metal, such as magnesium, calcium, barium or mixtures of such metals. When trivalent, the metal M can be aluminum. In one embodiment the metal is an alkaline earth metal and in another embodiment the metal is calcium.

The monomeric units of the above combine in such a way with itself x number of times to form oligomers of hydrocarbyl phenol. Oligomers are described as dimers, trimers, tetramers, pentamers and hexamers when x is equal to 0, 1, 2, 3, and 4. Typically the number of oligomers represented by x can be in the range from 0, 1 to 10, 9, 8, 6, 5 or even 2. Typically an oligomer is present in significant quantities if concentrations are above 0.1, 1 or even 2 percent by weight. Typically an oligomer is present in trace amounts if concentrations are less than 0.1 percent by weight. Generally for at least 50 percent of the molecules, x is 2 or higher. In some embodiments the overall sulfur-containing phenate detergent contains less than 20 percent by weight dimeric structures.

In the structure above each R⁵ can be hydrogen or a hydrocarbyl group containing from 4, 6, 8 or 9 to 80, 45, 30 or 20 carbon atoms, or 14 carbon atoms. The number of R⁵ substituents (w) other than hydrogen on each aromatic ring can be in the range from 0 or 1 to 4, 3 or 2, or be just 1. Where two or more hydrocarbyl groups are present they may be the same or different and the minimum total number of carbon atoms present in the hydrocarbyl substituents on all the rings, to ensure oil solubility, can be 8 or 9. The preferred components include 4-alkylated phenols containing alkyl groups with the number of carbon atoms between 9 and 14, for example 9, 10, 11, 12, 13, 14 and mixtures thereof. The 4-alkylated phenols typically contain sulphur at position 2. The phenate detergent represented by the structure above may also be overbased using an alkaline earth metal base, such as calcium hydroxide.

In some embodiments the phenate detergent used in the present invention is an overbased sulfurized alkaline earth metal hydrocarbyl phenate, which may optionally be modified by the incorporation of at least one carboxylic acid having the formula: R—CH(R¹)—COOH where R is a C₁₀ to C₂₄ straight chain alkyl group and R¹ is hydrogen, or an anhydride or ester thereof. Such overbased phenates may be prepared by reacting: (i) a non-overbased sulfurized alkaline earth metal hydrocarbyl phenate as described above, (ii) an alkaline earth metal base which may be added as a whole or in increments, (iii) either a polyhydric alcohol having from 2 to 4 carbon atoms, a di- or tri-(C₂ to C₄) glycol, an alkylene glycol alkyl ether or a polyalkylene glycol alkyl ether, (iv) a lubricating oil present as a diluent, (v) carbon dioxide added subsequent to each addition of component (ii), and optionally (vi) at least one carboxylic acid as defined above.

Any of the detergents described above may be used alone or in combination with one another. In one embodiment the individual detergents used contain magnesium, barium, strontium, sodium, calcium, potassium, or combinations thereof. In other embodiments the detergents contain calcium.

In one embodiment wherein the detergent includes an overbased calcium sulfonate with a total base number of at least 300 with an alkyl chain derived from polyisobutylene, an overbased calcium sulfonate with a total base number of more than 10 but less than 100, or combinations thereof.

In some embodiments the alkyl chain of high-1′13N detergent has a number average molecular weight (Mn) of from 500, 850, or 950 to 5000, 3000, 2500, 2000, 1600, or 1200. In one embodiment the alkyl chain has an Mn from 850 to 1600, or is even about 1000.

In some embodiments the alkyl chain of low-TBN detergent has a Mn of from 100, 200, or 300 to 1000, 750, 500, or 450. In one embodiment the alkyl chain has an Mn from 300 to 450.

The detergent component may be present in the fuel composition from 100, 200, 500 or even 750 to 10,000, 5,000, 1,500, 1,000 or even 500 ppm (all on a weight basis). In other embodiments, such as when the compositions are in an additive concentrate form, the detergent component may be present in the composition from 0.01%, 0.1%, 0.5%, 1% or even 3.0% to 20%, 15%, 12%, 10%, or even 5% where all percent values are on a weight basis.

### INDUSTRIAL APPLICATION

The present invention provides a method of operating an engine, and particularly a marine diesel engine. The method includes: supplying to the engine a fuel composition made up of (a) a marine fuel and (b) a metal-containing detergent where the fuel composition has a sulfur content of at least 0.5 percent by weight. At the same time, the method may also include: supplying to the engine a cylinder lubricating composition wherein the total base number (TBN) of the cylinder lubricating composition is less than 70.

As described above, the methods of the present invention can result in improved corrosion control in the engine as the methods help to better control the levels of corrosive combustion byproducts in the engine, and specifically in the cylinder and/or the oil present in the cylinder. The methods may also allow a lower TBN lubricant, such as a lower TBN cylinder oil, to be used effectively with a fuel, such as a marine diesel fuel, with a higher sulfur content than would otherwise be possible. The methods may also allow a higher sulfur content fuel, such as a marine diesel fuel, to be used effectively with a lubricant, such as a cylinder oil, with a lower TBN than would otherwise be possible.

The means by which the detergent component of the present invention is introduced to the fuel is not overly limited. The detergent may be added to the fuel at the refinery, at one of the distribution or storage points the fuel passes through, at the fuel station where vehicles are filled, or at the vehicle itself. The detergent may be present as a fuel additive, much like the other fuels additives discussed above, or it may be added as a top treat, by a fuel marketer and/or distributor, or even by the engine operator, adding the top treat to the fuel in the fuel tank of the operator's engine. The detergent may also be added to the engine via a dosing mechanism connected to the engine that adds the detergent to the fuel at any point in the engine's fuel system, at a controllable rate. In such embodiments the detergent may be added to the fuel tank, to the fuel pump, via the fuel filter, or to the cylinder by adding the detergent to the fuel just as the fuel enters the cylinder.

In any of the embodiments described above the detergent may be added as a single additive or in the form of an additive package and/or concentrate containing multiple additives. In either case, the detergent can be mixed with an optional solvent or diluent, such as mineral oil or fuel oil. The additional additives include any fuel additive, including those described above.

In some embodiments the weight ratio of the basicity present in the engine and/or cylinder, during operation of the engine, delivered by the fuel composition (which may be calculated by multiplying the TBN of the fuel by the rate at which the fuel is used by the engine and/or the amount of fuel used per engine cycle) over the basicity in the engine delivered by the lubricant composition (which may be calculated by multiplying the TBN of the cylinder lubricant by the rate at which the cylinder lubricant is used by the engine and/or the amount of cylinder lubricant used per engine cycle) is greater than or equal to 0.5, 0.75, 0.8, 1 or even 1.1, 1.2 or 1.5.

The following examples provide an illustration of the invention. These examples are non-exhaustive and are not intended to limit the scope of the invention.

### EXAMPLES

### Comparative Example 1

A marine diesel engine is operated for 100 hours while being supplied a marine diesel fuel having a sulfur content of 5% by weight. The engine is also supplied a cylinder lubricant with a TBN of 40.

### Inventive Example 1A

The test of Comparative Example 1 is repeated except that the marine diesel fuel is treated with 5% by weight of an overbased calcium sulfonate with a total base number of at least 300.

### Inventive Example 1B

The test of Comparative Example 1 is repeated except that the marine diesel fuel is treated with 5% by weight of an overbased calcium sulfonate with a total base number of 85.

The engine emissions over the course of the test and the residual TBN of the cylinder lubricant at the end of the test may be compared to show the benefits of the present invention.

### Comparative Example 2

A marine diesel engine is operated for 100 hours while being supplied a marine diesel fuel having a sulfur content of 2% by weight. The engine is also supplied a cylinder lubricant with a TBN of 40.

### Inventive Example 2A

The test of Comparative Example 2 is repeated except that the marine diesel fuel is treated with 5% by weight of an overbased calcium sulfonate with a total base number of at least 300.

### Inventive Example 2B

The test of Comparative Example 2 is repeated except that the marine diesel fuel is treated with 5% by weight of an overbased calcium sulfonate with a total base number of 85.

The engine emissions over the course of the test and the residual TBN of the cylinder lubricant at the end of the test may be compared to show the benefits of the present invention.

### Comparative Example 3

A marine diesel engine is operated for 100 hours while being supplied a marine diesel fuel having a sulfur content of 5% by weight. The engine is also supplied a cylinder lubricant with a TBN of 70.

### Inventive Example 3A

The test of Comparative Example 3 is repeated except that the marine diesel fuel is treated with 5% by weight of an overbased calcium sulfonate with a total base number of at least 300.

### Inventive Example 3B

The test of Comparative Example 3 is repeated except that the marine diesel fuel is treated with 5% by weight of an overbased calcium sulfonate with a total base number of 85.

The engine emissions over the course of the test and the residual TBN of the cylinder lubricant at the end of the test may be compared to show the benefits of the present invention.

### Comparative Example 4

A marine diesel engine is operated for 100 hours while being supplied a marine diesel fuel having a sulfur content of 5% by weight. The engine is also supplied a cylinder lubricant with a TBN of 40.

### Inventive Example 4A

The test of Comparative Example 4 is repeated except that the marine diesel fuel is treated with 5% by weight of an overbased calcium sulfonate with a total base number of at least 300.

### Inventive Example 4B

The test of Comparative Example 4 is repeated except that the marine diesel fuel is treated with 5% by weight of an overbased calcium sulfonate with a total base number of 85.

The engine emissions over the course of the test and the residual TBN of the cylinder lubricant at the end of the test may be compared to show the benefits of the present invention.

Each of the documents referred to above is incorporated herein by reference. Except in the Examples, or where otherwise explicitly indicated, all numerical quantities in this description specifying amounts of materials, reac-tion conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

What is claimed is:

1. A method of operating a marine diesel engine comprising the steps:
(I) supplying to the engine a fuel composition comprising
(a) a marine fuel; and
(b) a metal-containing detergent;
wherein the fuel composition has a sulfur content of at least 0.5 percent by weight; and
(II) supplying to the engine a cylinder lubricating composition wherein the total base number (TBN) of the cylinder lubricating composition is no more than 70.

2. The method of claim 1 wherein the weight ratio of the basicity present in the engine delivered by the fuel composition over the basicity in the engine delivered by the cylinder lubricant composition is greater than or equal to 1.

3. The method of the claim 1 wherein the marine diesel engine is a 4-stroke trunk piston engine or a 2-stroke cross-head engine.

4. The method of the claim 1 wherein the fuel composition is a high sulfur fuel having a sulfur content of greater than 4% by weight and the cylinder lubricating composition is a low TBN lubricant having a TBN of less than 50;
wherein the marine diesel engine has equivalent or reduced sulfur trioxide exhaust emissions and/or an equivalent or increased residual cylinder lubricant TBN, compared to the values obtained where: (i) the engine is operated with a fuel having a lower sulfur content; (ii) the engine is operated with a cylinder lubricant having a higher TBN; or (iii) combinations thereof.

5. The method of claim 1 wherein the fuel composition is a low sulfur fuel having a sulfur content of 0.5 to 4% by weight and the cylinder lubricating composition is a low TBN lubricant having a TBN of no more than 40;
wherein the marine diesel engine has equivalent or reduced sulfur trioxide exhaust emissions and/or and an equivalent or increased residual cylinder lubricant TBN, compared to the values obtained where: (i) the engine is operated with a fuel composition that does not contain component (b); (ii) the engine is operated with a fuel having a lower sulfur content; (iii) the engine is operated with a cylinder lubricant having a higher TBN; or (iv) combinations thereof.

6. The method of claim 1 wherein the sulfur trioxide exhaust emissions of the engine are reduced by at least 10% and/or the residual TBN of the cylinder lubricant is increased by at least 10%, compared to the values obtained where: (i) the engine is operated with a fuel composition that does not contain component (b); (ii) the engine is operated with a fuel having a lower sulfur fuel; (iii) the engine is operated with a cylinder lubricant having a higher TBN; or (iv) combinations thereof.

7. The method of claim 1 wherein the detergent comprises overbased metal sulfonates, alkyl phenol detergents, salicylate detergents, carboxylates, or combinations thereof.

8. The method of claim 1 wherein the detergent comprises magnesium, barium, strontium, sodium, calcium, potassium, or combinations thereof.

9. The method of claim 1 wherein the detergent comprises: (i) an overbased calcium sulfonate with a total base number of greater than 300 with an alkyl chain derived from polyisobutylene where the chain has a number average molecular weight of from about 850 to about 1600, (ii) an overbased calcium sulfonate with a total base number of more than 10 but less than 100 with an alkyl chain having a number average molecular weight of from about 300 to 450, or (iii) combinations thereof.

10. The method of claim 1 wherein the marine fuel comprises (i) a distillate fuel, (ii) an intermediate fuel, (iii) a residual fuel, or (iv) combinations thereof.

11. The method of claim 1 wherein the marine fuel comprises: No. 2 diesel fuel, No. 4 diesel fuel, No. 6 diesel fuel, heavy fuel oil bunker fuel, residual fuel, or combinations thereof.

12. The method of claim 1 wherein the fuel composition further comprises: a combustion improver, a cetane improver, an emulsifier, an antioxidant, an antifoam agent, a corrosion inhibitor, a wax crystal modifier, a distillate flow improver, a liner lacquering reducing agent, an asphaltene dispersant, a demulsifier, or combinations thereof.

13. The method of the claim 1 wherein the fuel composition is a high sulfur fuel having a sulfur content of greater than 4% by weight and the cylinder lubricating composition is a low TBN lubricant having a TBN of less than 50;
wherein the marine diesel engine has equivalent sulfur trioxide exhaust emissions and/or equivalent residual cylinder lubricant TBN, compared to the values obtained where:
(i) the engine is operated with a fuel composition that does not contain component (b); and also
(ii) the engine is operated with a fuel having a lower sulfur content;
(iii) the engine is operated with a cylinder lubricant having a higher TBN; or
(iv) combinations thereof.

14. The method of the claim 1 wherein the fuel composition is a high sulfur fuel having a sulfur content of greater than 4% by weight and the cylinder lubricating composition is a low TBN lubricant having a TBN of less than 50;
wherein the marine diesel engine has reduced sulfur trioxide exhaust emissions and/or increased residual cylinder lubricant TBN, compared to the values obtained where:
(i) the engine is operated with a fuel composition that does not contain component (b);
(ii) the engine is operated with a fuel having a lower sulfur content;
(iii) the engine is operated with a cylinder lubricant having a higher TBN; or
(iv) combinations thereof.
